(19) United States
(12) Patent Application Publication
(10) Pub. No.: US 2025/0102082 A1
(43) Pub. Date: Mar. 27, 2025

(54) DAMPER CLAMP

(71) Applicant: MacLean Power L.L.C., Fort Mill, SC (US)

(72) Inventors: Kenneth Matthew KUBIK, Alabaster, AL (US); Wei-Chung LIN, Alabaster, AL (US)

(73) Assignee: MacLean Power L.L.C., Fort Mill, SC (US)

(21) Appl. No.: 18/896,289

(22) Filed: Sep. 25, 2024

Related U.S. Application Data
(60) Provisional application No. 63/585,144, filed on Sep. 25, 2023.

(51) Int. Cl. F16L 3/10; F16L 3/11; H02G 7/05

(52) U.S. Cl. CPC F16L 3/1075; F16L 3/11; H02G 7/053

(57) ABSTRACT

A clamp for a cable is provided. The clamp has a first clamp portion and a second clamp portion that is moveable relative to the first clamp portion clamp a cable a cable. A pair of inserts is positioned between the first and second clamp portions for cushioning the cable and dampening vibrations. A keeper clamp portion is moveable relative to the first clamp portion and the second to provide sequential clamping of the cable. The keeper clamp portion is moved from an installation position to a first clamp position to clamp the cable between the keeper clamp portion and the first clamp portion. The second clamp portion is moved to a second clamp position to clamp the cable between the inserts positioned between the first and second clamp portions.

### CROSS-REFERENCE TO RELATED APPLICATIONS

This application claims the benefit of U.S. provisional application Ser. No. 63/585,144 filed Sep. 25, 2023, the disclosure of which is hereby incorporated in its entirety by reference herein.

### TECHNICAL FIELD

The present application relates to clamps used to support conductors for electric transmission.

### BACKGROUND

Clamps are used for the suspension and support of various types of cables, including power transmission lines, communication cables, and optical fiber cables. These clamps are designed to securely hold the cables in place while they are suspended aerially from poles or other supporting structures.

Clamps may be subjected to environmental and mechanical stresses. For example, cables are particularly vulnerable to aeolian vibrations, which are low-amplitude, high-frequency vibrations caused by wind. Such vibrations, along with other wind-induced movements, can cause fatigue or wear at the suspension points. In addition, the clamps are subjected to thermal stresses from environmental temperatures on the energized lines.

In addition to securing cables, clamps also play a significant role in maintaining the alignment and spacing of aerial installations. This helps prevent entanglement or sagging, which could lead to service interruptions or safety hazards. To meet these requirements, clamps must be easy to install, durable, and capable of providing consistent pressure on the cable without causing damage to the cable's structure.

### SUMMARY

In at least one embodiment, a clamp for holding a conductor is provided. The clamp has a clamp body having a first clamp portion and a second clamp portion pivotally connected to the first clamp. The second clamp portion is movable between an open position and a closed position. The first and second clamp portions have a damper insert to grip and contact the conductor. The clamp body includes a keeper portion to allow the clamp to be quickly installed upon the wire.

In at least one embodiment, a clamp for a cable is provided. The clamp includes a first clamp portion having a first cable groove for receiving a cable. The first cable groove extends transversely across the first clamp portion from a first clamp end to a second clamp end. A first pair of inserts is disposed in the first and second ends of the first clamp portion. A second clamp portion has a second cable groove that cooperates with the first cable groove to receive the cable. The second cable groove has a corresponding first clamp end and a corresponding second clamp end. A second pair of inserts disposed in the first and second ends of the second clamp portion. A keeper clamp portion has a third cable groove cooperating with the first clamp portion along an intermediate segment of the first cable groove.

According to another embodiment, the second clamp portion is pivotally connected to the first clamp portion along a hinge. The second clamp portion pivots between an open clamp position and a closed clamp position. In the closed clamp position, the first and second cable grooves define a cable channel between the first and second pairs of inserts.

According to another embodiment, the hinge is positioned below the first and second cable grooves.

According to another embodiment, the keeper clamp portion is pivotally connected to the first clamp portion along the hinge. The keeper clamp portion pivots between an open keeper position and a closed keeper position independent of the second clamp portion. The keeper clamp portion and the first clamp portion hold the cable without the second clamp portion being in the closed position.

According to another embodiment, keeper clamp portion has a third cable groove that cooperates with the first cable groove to hold the cable when the keeper clamp portion is in the closed keeper position.

According to another embodiment, the second clamp portion has a keeper window sized to receive the keeper clamp portion when the second clamp portion is in the closed clamp position.

According to another embodiment, the second cable groove has a first groove segment along the first end and a second groove segment along the second end, wherein the first groove segment is spaced apart from the second groove segment by the keeper window.

According to another embodiment, the clamp includes at least one keeper fastener extending through the keeper clamp portion and engaging the first clamp portion to hold the cable between the keeper clamp portion and the first clamp portion.

According to another embodiment, the at least one keeper fastener is positioned below the first cable groove. According to another embodiment, the at least one keeper fastener comprises two fasteners.

According to another embodiment, the clamp has a second fastener extending through the second clamp portion and engaging the first clamp portion to secure the second clamp portion to the first clamp portion, wherein the second fastener is positioned above the first and second cable grooves.

According to another embodiment, the keeper clamp portion has a width dimension extending in transversely, wherein the width dimension is greater than an end segment width of the first clamp portion including the first pair of inserts.

According to another embodiment, the width dimension of the keeper clamp portion is at least 1.5 times greater than the end segment width of the first clamp portion.

According to another embodiment, at least one of the first and second clamp portions include a stop-pin to provide a limit to the closed position.

In at least one embodiment, a clamp for a cable is provided. The clamp has a first clamp portion and a second clamp portion that is moveable relative to the first clamp portion clamp a cable a cable. A pair of inserts is positioned between the first and second clamp portions for cushioning the cable and dampening vibrations. A keeper clamp portion is moveable relative to the first clamp portion and the second to provide sequential clamping of the cable. The keeper clamp portion is moved from an installation position to a first clamp position to clamp the cable between the keeper clamp portion and the first clamp portion. The second clamp portion is moved to a second clamp position to clamp the cable between the inserts positioned between the first and second clamp portions.

In at least one embodiment, a method of clamping a cable is provided. A cable is positioned between a first clamp portion and a keeper clamp portion. The keeper clamp portion is fastened to the first clamp portion with at least a first fastener to hold the cable between the first clamp portion and the keeper portion. A second clamp portion is positioned against the cable opposite the first clamp portion. The second clamp portion is fastened to the first clamp portion with a second fastener to hold the cable between the first clamp portion and the second clamp portion.

According to another embodiment, the method includes tightening the first and second fasteners to a predetermined retention torque value, after initially fastening the first and second fasteners.

According to another embodiment, positioning the second clamp portion includes pivoting the second clamp portion from an open clamp position to a closed clamp position relative to the first clamp portion.

According to another embodiment, positioning the keeper clamp portion includes pivoting the keeper clamp portion from an open keeper position to a closed keeper position relative to the first clamp portion.

According to another embodiment, the at least a first fastener comprises two bolts that extend through the keeper clamp portion to the first clamp position.

### BRIEF DESCRIPTION OF THE DRAWINGS

FIG. 1 illustrates a perspective view of a clamp according to one embodiment of the present application, where the clamp is shown in a closed position holding a conductor or cable.

FIG. 2 illustrates a perspective view of the clamp according to one embodiment of the present application, where the keeper clamp portion remains in a closed position holding the conductor or cable, while a portion of the clamp is moved to an open position.

FIG. 3 illustrates a perspective view of the clamp according to one embodiment of the present application, where the clamp is shown in a fully open installation position.

FIG. 4 illustrates an end view of the clamp in FIG. 3 in the fully open position.

FIG. 5 illustrates a side view of the clamp in FIG. 1.

FIG. 6 illustrates an end view of the clamp in FIG. 1 in a closed position.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The clamp 10 is designed to hold a conductor or cable 12 used for high-voltage electric transmission effects of oscillations. The clamp 10 may have a clamp body 20 formed of aluminum. However, the clamp body 20 may be formed of other metals such as steel, reinforced polymer, composites, plastics, or other materials suitable for holding suspended conductors or cables. The clamp may be used with high power transmission cables for hub-voltage electric, or other applications like low power cables, communication cables or fiber optic cables, for example.

The clamp 10 includes inserts 36, 42. The inserts 36, 42 provide cushioning between the clamp body 20 and the cable 12. The inserts 36, 42 can prevent localized pressure points that could damage or deform the conductor or cable 12. Further, the inserts 36, 42 can dampen and absorb vibration or mechanical forces to reduce wear and fatigue on the conductor or cable 12. The inserts 36, 42 may be especially important in high-tension and high-voltage applications, where the cable is subjected to constant dynamic forces. By mitigating these stresses, inserts 36, 42 help extend the life of both the cable and the clamp system. The inserts 36, 42 may be formed of rubber or elastomeric materials such as EPDM, neoprene, or silicone, for example or other suitable material that can provide cushioning and help dampen vibrations and minimize the static and dynamic stresses.

The clamp body 20 has a clamp design that includes three clamp portions. A first clamp portion 22, a second clamp portion 24, and a keeper clamp portion 26 provide sequential clamping that provides a significant advancement in suspension hardware. The clamp portions 22, 24, 26 allow the clamp 10 to be quickly installed on the conductor and provide enhanced stability and durability, even during extreme temperature variations.

Traditional suspension clamps that use bushings or dampers formed of rubber or other elastomers are prone to loosening due to temperature fluctuations. As temperatures drop, the insert material may contract and/or harden, which can cause the clamp to loosen around the conductor or cable, leading to vibration concerns and audible noise. In these cold conditions, the insert is unable to maintain consistent pressure.

In the present application, the keeper clamp portion 26 maintains constant contact with the conductor or cable 12 and is unaffected by temperature changes because it is secured and tightened separate from the first and second clamp portions 22, 24. While the inserts continue to dampen aeolian vibrations, the keeper clamp portion 26 ensures a secure hold on the conductor, preventing the loosening typically seen in cold weather. This innovative solution using a separate keeper clamp portion 26 enhances the overall performance, reliability, and safety of the clamp over a diverse and large range of operating environments.

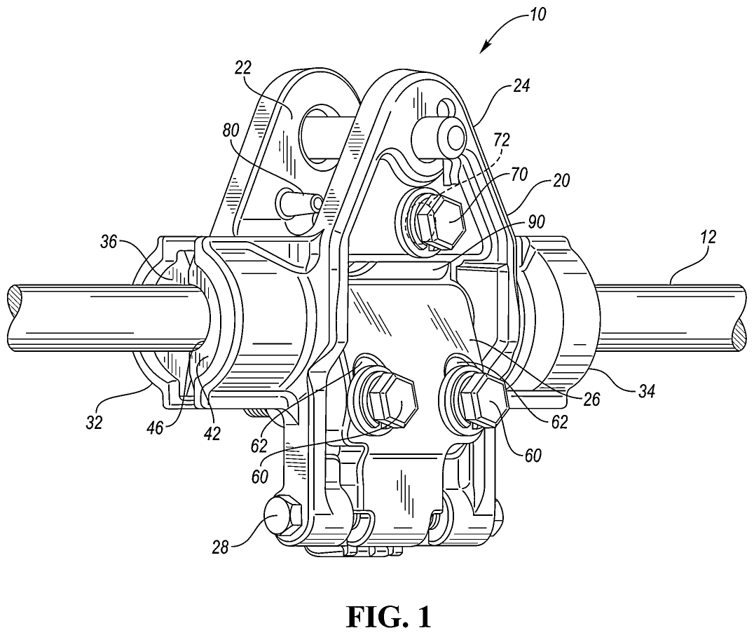

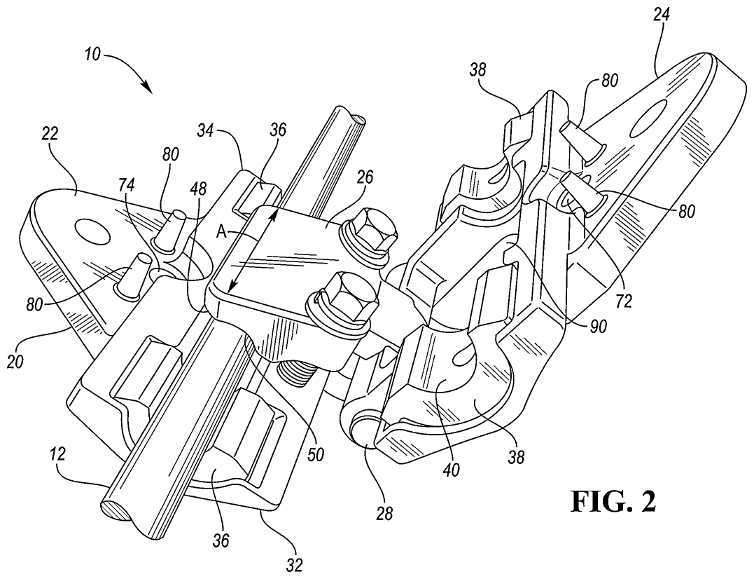

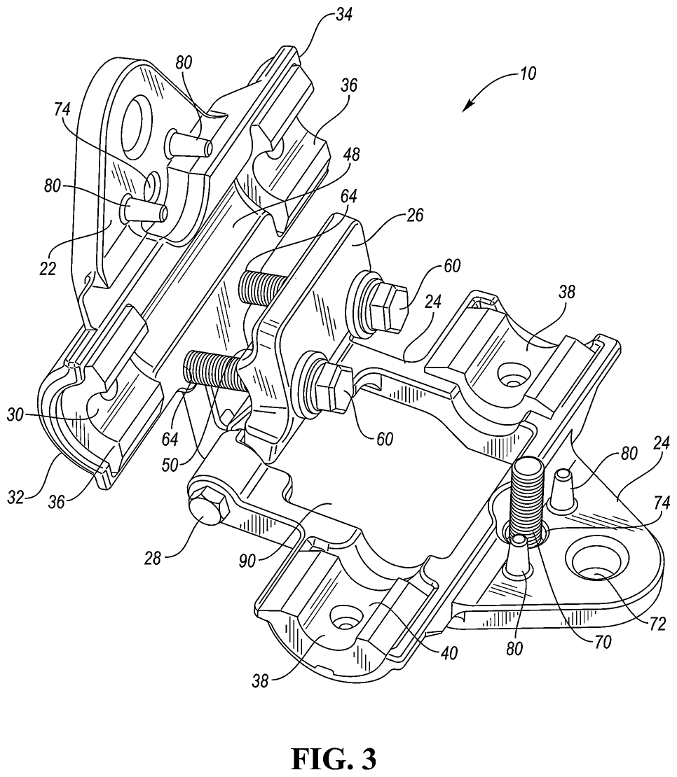

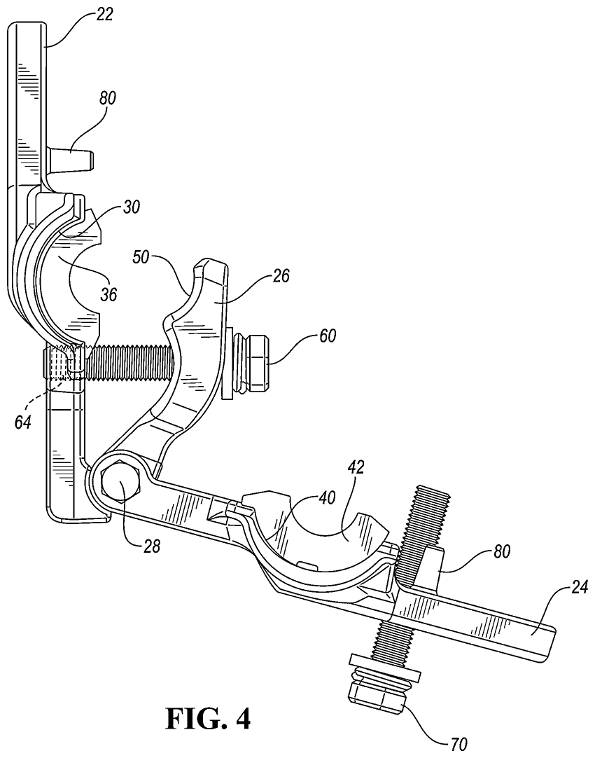

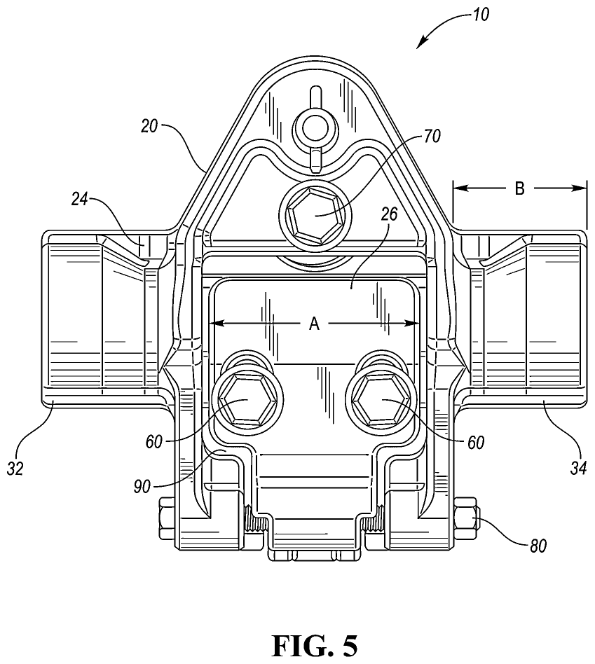

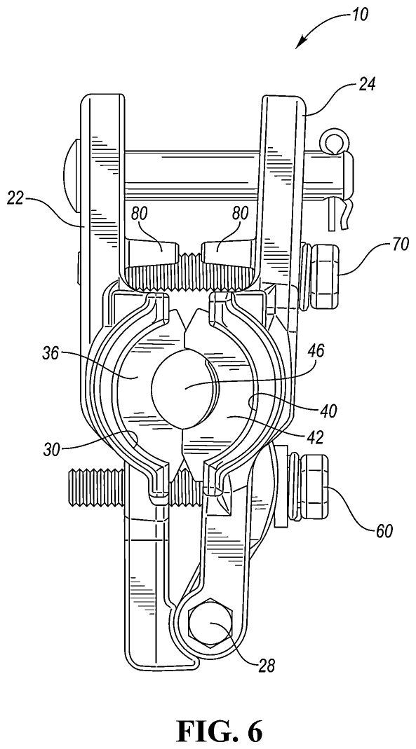

As shown in FIGS. 1-6, the clamp portions 22, 24, 26 are connected with a hinge 28. FIG. 1 illustrates the clamp with the clamp portions 22, 24, 26 in the closed position. FIG. 2 illustrates a first closed position where the keeper clamp portion 26 is hinged closed in a keeper closed position, but the second clamp portion 24 is hinged to an open position. FIGS. 3-4 illustrate the clamp in an open position. From the open position, the keeper clamp portion 26 initially pivots to a closed keeper position to grip the cable 12 with the first clamp portion 22. Next, the second clamp portion 24 is rotated to the closed position and cooperates with the first clamp portion 22.

The first clamp portion 22 has a cable groove 30 for receiving the cable 12. The cable groove 30 extends transversely across the first clamp portion 22 from a first end 32 of the clamp 24 to a second end 34. A damper insert 36 is positioned in the groove 30. As shown, the damper insert 36 includes a pair of inserts positioned along the first and second ends 32, 34 of the first clamp portion 22.

The second clamp portion 24 has a second cable groove 40. The second cable groove has a damper insert 42 disposed in the cable groove 40. As shown, the second damper insert 42 includes a pair of inserts positioned along the first and second ends 32, 34 of the second clamp portion 24.

The clamp body 20 also includes the keeper clamp portion 26 with a third cable groove 50. The keeper clamp portion 26 cooperates with the first clamp portion 22 along an intermediate segment 48 of the first cable groove 30.

The second clamp portion 24 is pivotally connected to the first clamp portion 22 along the hinge 28. As shown, the hinge 28 is positioned below the first and second cable grooves 30, 40 when the clamp 10 is installed from below the conductor or cable 12, as shown in FIG. 1-6. The clamp 10 may also be installed from above the cable, or at another orientation. When the second clamp portion 24 pivots from the open clamp position to the closed clamp position, a cable channel 46 is defined between the first and second inserts 36, 42.

The keeper clamp portion 26 is also pivotally connected to the first clamp portion along the hinge 28. The keeper clamp portion 26 can pivot independent of the second clamp portion 24. This allows the keeper clamp portion 26 and the first clamp portion 22 to hold the cable 12 without the second clamp portion 24 being in the closed position.

The keeper clamp portion 26 has a third cable groove 50 that cooperates with the first cable groove to hold the cable when the keeper clamp portion 26 is in the closed keeper position. The cable channel 46 in contact with the conductor or cable 12 includes this third cable groove 50. The third cable groove 50 may not have any damper inserts.

A keeper fastener 60 extends through the keeper clamp portion 26 and engages the first clamp portion 22 to hold the cable 12 between the keeper clamp portion 26 and the first clamp portion 22. The keeper clamp portion 26 includes at least one keeper fastener 60. As shown, the clamp 10 includes two keeper fasteners 60 spaced apart in the transverse direction. However, any suitable number of fasteners 60 may be used. For example, the keeper clamp portion 26 may have one keeper fastener 60. One keeper fastener 60 may be centrally positioned on the keeper clamp portion 26.

The keeper clamp portion 26 has a through-hole 62 that extends through the keeper clamp portion 26 for receiving the keeper fastener 60. The first clamp portion 22 has a threaded opening 64 which engages the fastener 60. The keeper fastener 60, the though-hole 62, and the threaded opening 64 are positioned below the first cable groove 30 and below the keeper cable groove 50. The clamp 10 may also be installed from above the cable, or at another orientation.

The clamp 10 of the present application provides a method of clamping a cable that allows sequential clamping of the conductor or cable 12. As shown in FIGS. 3-4, the keeper clamp portion 26 may be moved to a fully open installation position by loosening the fastener 60 on the keeper clamp portion 26 without fully removing the fastener 60 from the threaded opening 64. The fastener 60 can be loosened to a maximum open position to provide a spacing to install the largest conductor or cable diameter, while still being captive in the clamp portions 22, 26. This provides the advantage that the clamp 10 can be positioned on the conductor or cable without misplacing the fasteners 60 that become separated from the clamp. The fastener 60 may be a bolt or threaded fastener, as shown. The fastener 60 may be any suitable fastener to adjust the engagement between the keeper clamp portion 26 and the first clamp portion 22.

After the keeper fastener 60 is loosened, the clamp 10 may be positioned on the conductor or cable 12. The keeper fastener 60 can then be tightened to move the keeper clamp portion 26 to the keeper closed position, as shown in FIG. 2. The fastener 60 is tightened until the keeper clamp portion 26 holds the conductor or cable 12 between the first clamp portion 22 and the keeper portion 26. The keeper fasteners 60 may be tightened by hand or with minimal torque requirements during this step.

Next, in the sequential clamping method, the second clamp portion 24 is moved to the closed position against the conductor or cable 12. A clamp fastener 70 extends through a through-opening 72 in the second clamp portion 24. The clamp fastener 70 engages a threaded opening 74 in the first clamp portion 22 to secure the second clamp portion 24 to the first clamp portion 22. The fastener 70 may be a bolt or threaded fastener, as shown. The fastener may be any suitable fastener to secure the second clamp portion 24 and the first clamp portion 22. As shown in the Figures, the second fastener 70 is positioned above the first and second clamp grooves 30, 40, so the keeper fastener 60 is opposite the first and second clamp grooves 30, 40.

Initially, the fastener 70 may be tightened by hand or with minimal torque requirements. The keeper fastener 60 and clamp fastener 70 may then be tightened to a predetermined retention torque value, after initially fastening the first and second fasteners. The predetermined torque value may be a function of the size of the conductor or cable. For example, a smaller conductor or cable, up to about 0.6 inches, may have the fasteners 60, 70 tightened to a predetermined value of 15 ft-lbs of torque. In a conductor or cable in the range of approximately 0.6-0.9 inches, the fasteners 60, 70 may be tightened to a predetermined value of 25 ft-lbs of torque. In a conductor or cable in the range of approximately 0.8-1.6 inches, the fasteners 60, 70 may be tightened to a predetermined value of 45 ft-lbs of torque. In a conductor or cable in the range of approximately 1.5-2.0 inches or greater, the fasteners 60, 70 may be tightened to a predetermined value of 60 ft-lbs of torque. The predetermined torque may vary based on other factors, such as materials, dimensions, and application, among others. In another embodiment, the keeper fastener 60 may be tightened to a predetermined torque value that is different than a second predetermined torque value for the clamp fastener. In a further embodiment, the keeper fastener 60 may be tightened to a predetermined torque value that is greater than a second predetermined torque value for the clamp fastener.

As discussed above, the keeper clamp portion 26 maintains direct contact with the conductor or cable without any insert in between the keeper clamp portion 26 and the conductor or cable 12. The keeper clamp portion 26 provides positive contact to mitigate slip. The keeper clamp portion 26 has a width dimension A that is greater than an end segment width B of the first clamp portion 22. The width dimension A of the keeper clamp portion 26 being greater than the end segment width B helps maintain sufficient clamping and prevents vibration, even during cold conditions when the material of the inserts naturally shrinks and hardens. In one example, the width dimension A of the keeper clamp portion 26 is at least 1.5 times greater than the end segment width B of the first clamp portion 22.

In addition, the keeper clamp portion 26 enhances the high-temperature thermal performance of the clamp 10. In hot conditions or during ordinary loads of the conductor or cable, the insert may swell or expand compared to a cold condition in which the clamp was installed. In traditional clamps, this expansion may cause durability issues and may even require the clamp to be readjusted. In the clamp 10 of the present application, the keeper clamp portion 26 is able to provide direct clamping on the conductor or cable that is independent of the inserts 36, 42. This allows the clamp fastener 70 to be set at a predetermined torque value which accounts for temperature variations and does not require extra torque when the clamp is being installed during in cold environmental situations. As such, the clamp 10 of the present application may have higher thermal ratings than traditional clamps. For example, the clamp 10 may have a standard continuous thermal rating of 125-degrees C. and a continuous high temperature rating of 200-degrees C. In addition, the clamp 10 may have a 2-hour emergency thermal rating of 150-degrees C. and an emergency high temperature rating of 250-degrees C. In a further embodiment, the thermal benefits may allow the clamp 10 to be suitable for Extra High Voltage (EHV) applications. For example, the clamp 10 may be used in EHV application for ensuring corona-free performance in bundled 345 kV to 765 kv configurations or other configurations.

As shown in the drawings, the keeper clamp portion 26 is positioned between the ends 32, 34 to grip an intermediate segment 48. The second clamp portion 24 has a keeper window 90 sized to receive the keeper clamp portion 26 when the second clamp portion 24 is in the closed clamp position. The keeper window 90 extends through the second clamp portion 24 and interrupts the second cable groove 40. The second cable groove 40 has a first groove segment 92 along the first end 32 and a second groove segment 94 along the second end 34. The first groove segment 92 is spaced apart from the second groove segment 94 by the keeper window 90.

The clamp body 20 also includes pins 80. The pins provide a pivot stop to prevent over-torque of the clamp fastener 70 connecting the first and second clamp portions 22, 24. The pins 80 may extend from at least one of the first and second clamp portions 22, 24 to limit the closed position and prevent over-torque which could over-compress the inserts 36, 42. For example, the pins 80 may help prevent over-torque of the fasteners 60, 70 when the clamp is installed. This prevents over-torque when the installer does not have correct tools, correct training, or even during cold ambient conditions.

In addition to the benefits and advantages discussed above, the clamp 10 provides other additional features and benefits. The clamp 10 is compatible with armor rods, further enhancing its versatility and application range. The clamp 10 has easy installation and has captive fasteners 60, 70 to prevent loss during installation. The clamp 10 is also hot stick applicable.

The clamp is a significant advancement in suspension hardware technology. The clamp solves the shortcomings of traditional cushion grip clamps, particularly the issue of loosening during temperature changes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A clamp for a cable comprising:
a first clamp portion having a first cable groove for receiving a cable, the first cable groove extending transversely across the first clamp portion from a first clamp end to a second clamp end;
a first pair of inserts disposed in the first and second ends of the first clamp portion;
a second clamp portion having a second cable groove cooperating with the first cable groove to receive the cable, the second cable groove having a corresponding first clamp end and a corresponding second clamp end;
a second pair of inserts disposed in the first and second ends of the second clamp portion; and
a keeper clamp portion having a third cable groove cooperating with the first clamp portion along an intermediate segment of the first cable groove.

2. The clamp of claim 1, wherein the second clamp portion is pivotally connected to the first clamp portion along a hinge,
wherein the second clamp portion pivots between an open clamp position and a closed clamp position,
wherein in the closed clamp position, the first and second cable grooves define a cable channel between the first and second pairs of inserts.

3. The clamp of claim 2, wherein the hinge is positioned below the first and second cable grooves.

4. The clamp of claim 2, wherein the keeper clamp portion is pivotally connected to the first clamp portion along the hinge,
wherein the keeper clamp portion pivots between an open keeper position and a closed keeper position independent of the second clamp portion such that the keeper clamp portion and the first clamp portion hold the cable without the second clamp portion being in the closed position.

5. The clamp of claim 4, wherein the keeper clamp portion has a third cable groove that cooperates with the first cable groove to hold the cable when the keeper clamp portion is in the closed keeper position.

6. The clamp of claim 4, wherein the second clamp portion has a keeper window sized to receive the keeper clamp portion when the second clamp portion is in the closed clamp position.

7. The clamp of claim 6, wherein the second cable groove comprises a first groove segment along the first end and a second groove segment along the second end, wherein the first groove segment is spaced apart from the second groove segment by the keeper window.

8. The clamp of claim 4, further comprising at least one keeper fastener extending through the keeper clamp portion and engaging the first clamp portion to hold the cable between the keeper clamp portion and the first clamp portion.

9. The clamp of claim 8, wherein the at least one keeper fastener is positioned below the first cable groove.

10. The clamp of claim 8, wherein the at least one keeper fastener comprises two fasteners.

11. The clamp of claim 1, further comprising a second fastener extending through the second clamp portion and engaging the first clamp portion to secure the second clamp portion to the first clamp portion, wherein the second fastener is positioned above the first and second cable grooves.

12. The clamp of claim 1, wherein the keeper clamp portion has a width dimension extending in transversely, wherein the width dimension is greater than an end segment width of the first clamp portion including the first pair of inserts.

13. The clamp of claim 12, wherein the width dimension of the keeper clamp portion is at least 1.5 times greater than the end segment width of the first clamp portion.

14. The clamp of claim 1, wherein at least one of the first and second clamp portions include a stop-pin to provide a limit to the closed position.

15. A clamp for a cable comprising:
a first clamp portion;
a second clamp portions moveable relative to the first clamp portion clamp a cable a cable;
a pair of inserts positioned between the first and second clamp portions for cushioning the cable and dampening vibrations;
a keeper clamp portion moveable relative to the first clamp portion and the second to provide sequential clamping of the cable,
wherein the keeper clamp portion is moved from an installation position to a first clamp position to clamp the cable between the keeper clamp portion and the first clamp portion,
wherein the second clamp portion is moved to a second clamp position to clamp the cable between the inserts positioned between the first and second clamp portions.

16. A method of clamping a cable, comprising:
positioning a cable between a first clamp portion and a keeper clamp portion;
fastening the keeper clamp portion to the first clamp portion with at least a first fastener to hold the cable between the first clamp portion and the keeper portion;
positioning a second clamp portion against the cable opposite the first clamp portion; and
fastening the second clamp portion to the first clamp portion with a second fastener to hold the cable between the first clamp portion and the second clamp portion.

17. The method of claim 16, further comprising tightening the first and second fasteners to a predetermined retention torque value, after initially fastening the first and second fasteners.

18. The method of claim 16, wherein positioning the second clamp portion comprises pivoting the second clamp portion from an open clamp position to a closed clamp position relative to the first clamp portion.

19. The method of claim 16, wherein positioning the keeper clamp portion comprises pivoting the keeper clamp portion from an open keeper position to a closed keeper position relative to the first clamp portion.

20. The method of claim 16, wherein the at least a first fastener comprises two bolts that extend through the keeper clamp portion to the first clamp position.
